(19) United States
(12) Patent Application Publication
(10) Pub. No.: US 2020/0234355 A1
(43) Pub. Date: Jul. 23, 2020

(54) METHODS AND SYSTEMS RELATING TO POTENTIAL ASSET REALIZATION

(71) Applicant: NATHAN PHILLIP SURGESON, RUSSELL (CA)

(72) Inventor: NATHAN PHILLIP SURGESON, RUSSELL (CA)

(21) Appl. No.: 16/250,575

(22) Filed: Jan. 17, 2019

(51) Int. Cl. G06Q 30/06; H04L 29/08

(52) U.S. Cl. CPC G06Q 30/0613; H04L 67/32

(57) ABSTRACT

The present invention is directed to asset management and more particularly to integrated software systems and methods allowing asset owners to establish information relating to their assets, establish indications of potential asset disposal, and manage realization of assets by disposal.

### FIELD OF THE INVENTION

This invention relates to asset management and more particularly to integrated software systems and methods allowing asset owners to establish information relating to their assets, establish indications of potential asset disposal, and manage realization of assets by disposal.

### BACKGROUND OF THE INVENTION

An individual, business or organization acquires and disposes of a variety of tangible or intangible assets over time. However, when it comes to disposing of an asset there is always uncertainty on the part of the asset owner as to whether anyone is interested in acquiring the asset and what to establish as its requirements for disposing of the asset. At present the asset owner is essentially forced to establish a remuneration for the asset and to offer it for disposal. Similarly, another party seeking an asset must wait and see whether any asset owner offers an asset for sale which meets their requirements.

Accordingly, it would be beneficial to provide asset owners with an ability to establish a potential level of interest in the asset based upon potential asset purchasers establishing listings within a software application and/or software service which the asset owner's asset is matched against. Similarly, it would be beneficial to provide potential asset purchasers with an ability to receive notifications that an asset owner has established a listing with a software application and/or software service relating to an asset that matches a requirement established by the potential asset purchaser.

It would be further beneficial for embodiments of the invention to support requirements of micro, small and medium enterprises (MSMEs) (European Community definitions for MSMEs being enterprises with up to 10, 50 and 250 employees respectively) as well as businesses, individuals, organizations etc. in establishing market places for a diverse range of assets and supporting interfaces to the software application and/or software service allowing asset owners and potential asset purchasers to establish their differing listings, establish market analysis, etc.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating asset management and more particularly to integrated software systems and methods allowing asset owners to establish information relating to their assets, establish indications of potential asset disposal, and manage realization of assets by disposal.

In accordance with an embodiment of the invention there is provided a method comprising:
establishing a plurality of sets of first data upon a server established by a plurality of potential asset purchasers, each set of first data relating to characteristics of a first asset established by a potential asset purchaser of the plurality of potential asset purchasers which they seek to acquire;
establishing second data upon a server established by an asset owner, the second data relating to a second asset owned by the asset owner;
performing a matching process of the second data with the plurality of sets of first data;
providing to the asset owner a set of results of the matching process, the set of results comprising at least a number of the potential asset purchasers within the plurality of potential asset purchasers whose first data matches the second data; wherein
the asset owner has no association with the plurality of potential asset purchasers other than that they are both registered with a software application in execution upon the server.

In accordance with an embodiment of the invention there is provided a method comprising:

providing an electronic communication from a server notifying an asset owner that a potential asset purchasers exist for an asset registered by the asset owner with at least one of a software application in execution upon the server and a software service hosted by the server; wherein the electronic communication is triggered upon determining a match between a plurality of sets of first data established by a plurality of potential asset purchasers and second data established by the asset owner;
each set of first data relating to characteristics of a first asset established by a predetermined potential asset purchaser of the plurality of potential asset purchasers which they seek to acquire; the second data upon a server was established by the asset owner relating to a second asset owned by the asset owner; wherein
the identity of the potential asset purchaser of the plurality of potential asset purchasers is hidden from the asset owner during subsequent electronic communications when the asset owner has a first subscription level with the at least one of the software application in execution upon the server and the software service hosted by the server; and
the identity of the potential asset purchaser of the plurality of potential asset purchasers is revealed to the asset owner during subsequent electronic communications when the asset owner has a second subscription level with the at least one of the software application in execution upon the server and the software service hosted by the server.

In accordance with an embodiment of the invention there is provided a device comprising:
a server coupled to a communications network comprising a microprocessor, a database, and a network interface; wherein
the server is configured to send an electronic communication to an asset owner notifying the asset owner that a potential asset purchasers exist for an asset registered by the asset owner with at least one of a software application in execution upon the server and a software service hosted by the server;
the electronic communication is triggered upon determining a match between a plurality of sets of first data established by a plurality of potential asset purchasers and second data established by the asset owner;
each set of first data is stored within the database and relates to characteristics of a first asset established by a predetermined potential asset purchaser of the plurality of potential asset purchasers which they seek to acquire;
the second data is stored within the database and relates to characteristics established by the asset owner relating to a second asset owned by the asset owner; wherein
the server is configured to hide the identity of the potential asset purchaser of the plurality of potential asset purchasers from the asset owner during subsequent electronic communications when the asset owner has a first subscription level with the at least one of the software application in execution upon the server and the software service hosted by the server; and
the server is configured to reveal the identity of the potential asset purchaser of the plurality of potential asset purchasers to the asset owner during subsequent electronic communications when the asset owner has a second subscription level with the at least one of the software application in execution upon the server and the software service hosted by the server.

In accordance with an embodiment of the invention there is provided a server comprising:
a microprocessor;
a network interface coupled to a communications network;
a memory; wherein
the server is configured to:
store a plurality of sets of first data within the memory established by a plurality of potential asset purchasers, each set of first data received from a first electronic device associated with the potential asset purchaser of the plurality of potential asset purchasers connected to the communications network relating to characteristics of a first asset established by a potential asset purchaser of the plurality of potential asset purchasers which they seek to acquire;
store second data within the memory established by an asset owner, the second data relating to a second asset owned by the asset owner and received from a second electronic device associated with the asset owner connected to the communications network;
perform a matching process of the second data with the plurality of sets of first data;
provide to the asset owner electronic data relating to a set of results of the matching process, the set of results comprising at least a number of the potential asset purchasers within the plurality of potential asset purchasers whose first data matches the second data; wherein
the asset owner has no association with the plurality of potential asset purchasers other than that they are both registered with a software application in execution upon the server.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3 depicts an exemplary process flow for matching asset owners to asset purchasers based upon information entered by both parties within a software application according to an embodiment of the invention;

FIG. 4 depicts an exemplary process flow for an asset owner to list an asset within a software application according to an embodiment of the invention;

FIG. 5 depicts an exemplary process flow for a potential asset purchaser to list requirements for an asset they wish to acquire within a software application according to an embodiment of the invention;

FIG. 6 depicts an exemplary process flow for an asset owner to search for potential asset purchases with respect to an asset within a software application according to an embodiment of the invention;

FIG. 7 depicts an exemplary webpage of an asset posted by a user as employed within embodiments of the invention;

FIG. 8 depicts an exemplary webpage 800 of an asset owner GUI accessed by an asset owner within embodiments of the invention;

FIG. 9 depicts an exemplary webpage of information relating to an asset class meeting specific search criteria entered by a potential asset purchaser as employed within embodiments of the invention;

FIG. 10 depicts an exemplary webpage of an asset search performed by a potential asset purchaser as employed within embodiments of the invention;

FIG. 11 depicts an exemplary webpage of an asset search performed by a potential asset purchaser as employed within embodiments of the invention;

FIG. 12 depicts an exemplary webpage of a historical asset realization search performed by an asset owner as employed within embodiments of the invention; and

FIG. 13 depicts an exemplary webpage of a historical asset realization resulting from a historical asset realization search performed by an asset owner user as employed within embodiments of the invention.

### DETAILED DESCRIPTION

The present invention is directed to asset management and more particularly to integrated software systems and methods allowing asset owners to establish information relating to their assets, establish indications of potential asset disposal, and manage realization of assets by disposal.

The ensuing description provides representative embodiment(s) only and is not intended to limit the scope, applicability or configuration of the disclosure. Rather, the ensuing description of the embodiment(s) will provide those skilled in the art with an enabling description for implementing an embodiment or embodiments of the invention. It is being understood that various changes can be made in the function, and arrangement of elements without departing from the spirit and scope as set forth in the appended claims. Accordingly, an embodiment is an example or implementation of the inventions and not the sole implementation. Various appearances of “one embodiment”, “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristics described in connection with the embodiments is included in at least one embodiment, but not necessarily all embodiments, of the inventions. The phraseology and terminology employed herein are not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristics “may”, “might”, “can” or “could” be included, that particular component, feature, structure, or characteristics are not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof, and that the terms are not to be construed as specifying components, features, steps or integers. Likewise, the phrase “consisting essentially of”, and grammatical variants thereof, when used herein is not to be construed as excluding additional components, steps, features, integers or groups thereof, but rather that the additional features, integers, steps, components or groups thereof do not materially alter the basic and novel characteristics of the claimed composition, device or method. If the specification or claims refer to “an additional” element, that does not preclude there being more than one of the additional elements.

An “asset” as used herein and throughout this disclosure, refers to a resource owned by an individual, business, enterprise or organization (collectively an asset owner or owner). Anything tangible or intangible that can be owned or controlled to produce “value” to the owner can be an asset. Said value may be monetary or it may be measured in other non-financial systems of valuation such as bartering, feelings, etc. An asset is typically classified into one of two major asset classes: tangible assets and intangible assets. Tangible assets represent physical resources, objects, or rights and may include, but not be limited to, asset, buildings, portable electronic devices, fixed electronic devices, vehicles, furniture, electronics (for example televisions, computers, etc.), appliances, tickets for events, money, raw materials and clothing. Intangible assets are non-physical resources or rights that have a value and may include, but not be limited, goodwill, copyrights, trademarks, patents, computer programs, stocks, shares, reward scheme points and financial assets.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third-party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals whose biometric data may be, but not limited to, monitored, acquired, stored, transmitted, processed and analysed either locally or remotely to the user wherein by their engagement with a service provider, third party provider, enterprise, social network, social media etc. via a dashboard, web service, website, software plug-in, software application, graphical user interface acquires, for example, electronic content. This includes, but is not limited to, private individuals, employees of organizations and/or enterprises, members of community organizations, members of charity organizations, men, women, children, and teenagers.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat, include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

Reference to “content information” as used herein may refer to, but is not limited to, any combination of content features, content serving constraints, information derivable from content features or content serving constraints (referred to as “content derived information”), and/or information related to the content (referred to as “content related information”), as well as an extension of such information (e.g., information derived from content related information).

Reference to a “document” as used herein may refer to, but is not limited to, any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.). In the context of the Internet, a common document is a Web page. Web pages often include content and may include embedded information (such as meta-information, hyperlinks, etc.) and/or embedded instructions (such as Javascript, etc.). In many cases, a document has a unique, addressable, storage location and can therefore be uniquely identified by this addressable location such as a universal resource locator (URL) for example used as a unique address used to access information on the Internet.

“Document information” as used herein may refer to, but is not limited to, may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

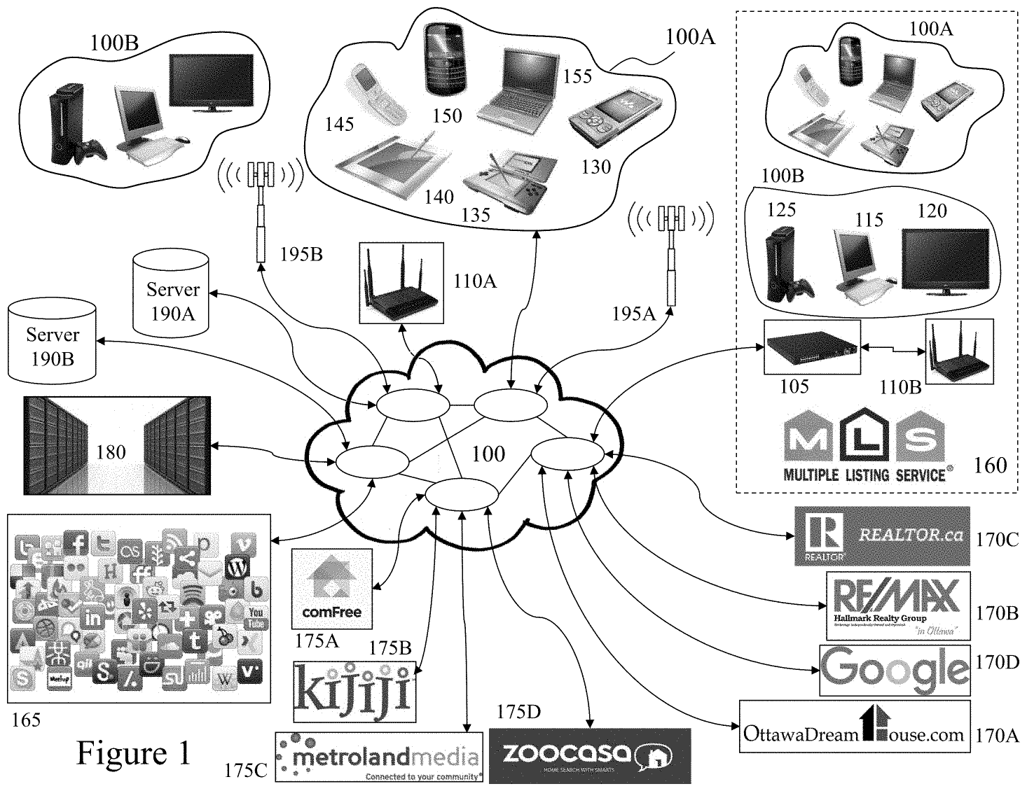

Within the embodiments of the invention described and depicted below in respect of FIGS. 1 to 13 these are described primarily from the viewpoint of an asset which is an asset, for example a house, an apartment, retail store, condominium etc. However, these descriptions with respect to embodiments of the invention are not to be viewed as limiting the scope of the invention. Accordingly, an asset may include anything may be viewed by one user (commonly referred to as the purchaser) as something that they wish to acquire ownership of from its current owner. As noted above this may include, but is limited to any tangible object, tangible asset, or intangible asset. Accordingly, it would be evident that Electronic Content Systems and Electronic Content Applications/Platforms (ECS-EAAPs) according to embodiments of the invention may be exploited by individuals, MSMEs, enterprises, organisations, large enterprises etc. within a variety of industries including, but not limited to, those within Entertainment, Government, Telecommunications, Hospitality Industry/Tourism, Mass Media, Healthcare/Hospitals, Public Health, Information Technology, Waste Disposal, Financial Services, Banking, Insurance, Investment Management, Consumer Goods, Professional Services, Accounting, Legal Services, Gambling, Retail Sales, Franchising, Asset, Education etc. and other elements of the service sector (tertiary sector) of the economy, i.e. activities where people offer their knowledge and time to improve productivity, performance, potential, and sustainability, what is termed affective labor. The basic characteristic of this sector is the production of services instead of end products which form part of intangible assets including, but not limited to, attention, advice, access, experience, and discussion.

However, it would be evident that Electronic Content Systems and Electronic Content Applications/Platforms (ECS-EAAPs) according to embodiments of the invention may be exploited by individuals, MSMEs, enterprises, organisations, large enterprises etc. within a variety of industries including, but not limited to, those within the secondary sector of the economy which is generally considered to be those portions of the economy that create a finished, usable product by either is direct production or construction or within the primary sector of the economy which is generally considered to be those portions of the economy making direct use of natural resources which includes, but is not limited to, agriculture, forestry, fishing and mining. Manufacturing industries that aggregate, pack, package, purify or process raw materials close to the primary producers are normally considered part of this sector, especially if the raw material is unsuitable for sale or difficult to transport long distances. Optionally, the individuals, MSMEs, enterprises, organisations, large enterprises etc. exploiting embodiments of the invention may be defined as a defined sub-division, subsidiary, parent organization, division, department, etc. of a large organization operating at regional, state, provincial, national, international level.

Accordingly, whilst the Figures in depicting exemplary graphical user interfaces, web pages etc. may relate to narrow geographical regions or specific products it would be evident that the embodiments of the invention may be applied at any geographical granularity or class/classes of products and/or services as defined by the user.

Referring to FIG. 1 there is depicted a network environment within which embodiments of the invention may be employed supporting Electronic Content Systems and Electronic Asset Applications/Platforms (ECS-EAAPs) according to embodiments of the invention. Such ECS-EAAPs, for example, supporting multiple communication channels, dynamic filtering, etc. As shown first and second user groups A and B respectively interface to a telecommunications network environment. Within the representative telecommunication architecture, a remote central exchange 180 communicates with the remainder of a telecommunication service provider's network via the network environment which may include for example long-haul OC-48/OC-192 backbone elements, an OC-48 wide area network (WAN), a Passive Optical Network, and a Wireless Link. The central exchange 180 is connected via the network environment to local, regional, and international exchanges (not shown for clarity) and therein through network environment to first and second cellular APs 195A and 195B respectively which provide Wi-Fi cells for first and second user groups A and B respectively. Also connected to the network environment are first and second Wi-Fi nodes A and B, the latter of which being coupled to network environment via router 105. Second Wi-Fi node B is associated with Enterprise 160, e.g. Multiple Listing Service™, comprising other first and second user groups A and B. Second user group B may also be connected to the network environment via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP A the first group of users A may employ a variety of PEDs including for example, laptop computer 155, portable gaming console 135, tablet computer 140, smartphone 150, cellular telephone 145 as well as portable multimedia player 130. Within the cell associated with second AP B are the second group of users B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups A and B. Alternatively the first and second user groups A and B may be geographically disparate and access the network environment through multiple APs, not shown for clarity, distributed geographically by the network operator or operators. First cellular AP 195A as show provides coverage to first user group A and environment 170, which comprises second user group B as well as first user group A. Accordingly, the first and second user groups A and B may according to their particular communications interfaces communicate to the network environment through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-0. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group A may form associations either through standards such as IEEE 802.15 and Bluetooth as well in an ad-hoc manner.

Also connected to the network environment are Social Networks (SOCNETS) 165, first and second service providers 170A and 170B respectively, e.g. Asset Chaser™ and RE-MAX™, first and second service providers 170C and 170D respectively, e.g. Realtor.ca™ and Google™ Also connected to the network environment are first to fourth web networks 175A to 175D respectively, e.g. comFree™, Kijiji™, MetrolandMedia, and Zoocasa™ together with others, not shown for clarity. Accordingly, an MSME such as first service provider 170A engages with multiple users, e.g. seller and buyers of residential and/or commercial properties or renters/rentees of rental residential and/or commercial properties as well as other brokers, agents, etc. wherein these may include those within their own organization, e.g. first service provider 170A (Asset Chaser™), another associated organization, e.g. second service provider 170B (RE-MAX™), or other service providers such as first and second service providers 170C and 170D, Realtor™ and Google™, respectively and first to fourth web networks 175A to 175D respectively. In addition, information relating to properties, the first service provider 170A, or a specific realtor within first service provider 170A may be obtained from one or more social networks such as LinkedIn™, Facebook™, etc.

Also depicted are first and second servers 190A and 190B may host according to embodiments of the inventions multiple services associated with a provider of contact management systems and contact management applications/platforms (ECS-EAAPs); a provider of a SOCNET or Social Media (SOME) exploiting ECS-EAAP features; a provider of a SOCNET and/or SOME not exploiting ECS-EAAP features; a provider of services to PEDS and/or FEDS; a provider of one or more aspects of wired and/or wireless communications; an Enterprise 160 such as Multiple Listing Service (MLS) exploiting ECS-EAAP features; license databases; content databases; image databases; content libraries; customer databases; websites; and software applications for download to or access by FEDs and/or PEDs exploiting and/or hosting ECS-EAAP features. First and second primary content servers 190A and 190B may also host for example other Internet services such as a search engine, financial services, third party applications and other Internet based services.

Accordingly, a consumer and/or customer (CONCUS) may exploit a PED and/or FED within an Enterprise 160, for example, and access one of the first or second primary content servers 190A and 190B respectively to perform an operation such as accessing/downloading an application which provides ECS-EAAP features according to embodiments of the invention; execute an application already installed providing ECS-EAAP features; execute a web based application providing ECS-EAAP features; or access content. Similarly, a CONCUS may undertake such actions or others exploiting embodiments of the invention exploiting a PED or FED within first and second user groups A and B respectively via one of first and second cellular APs 195A and 195B respectively and first Wi-Fi nodes A. It would also be evident that a CONCUS may, via exploiting network environment communicate via telephone, fax, email, SMS, social media, etc.

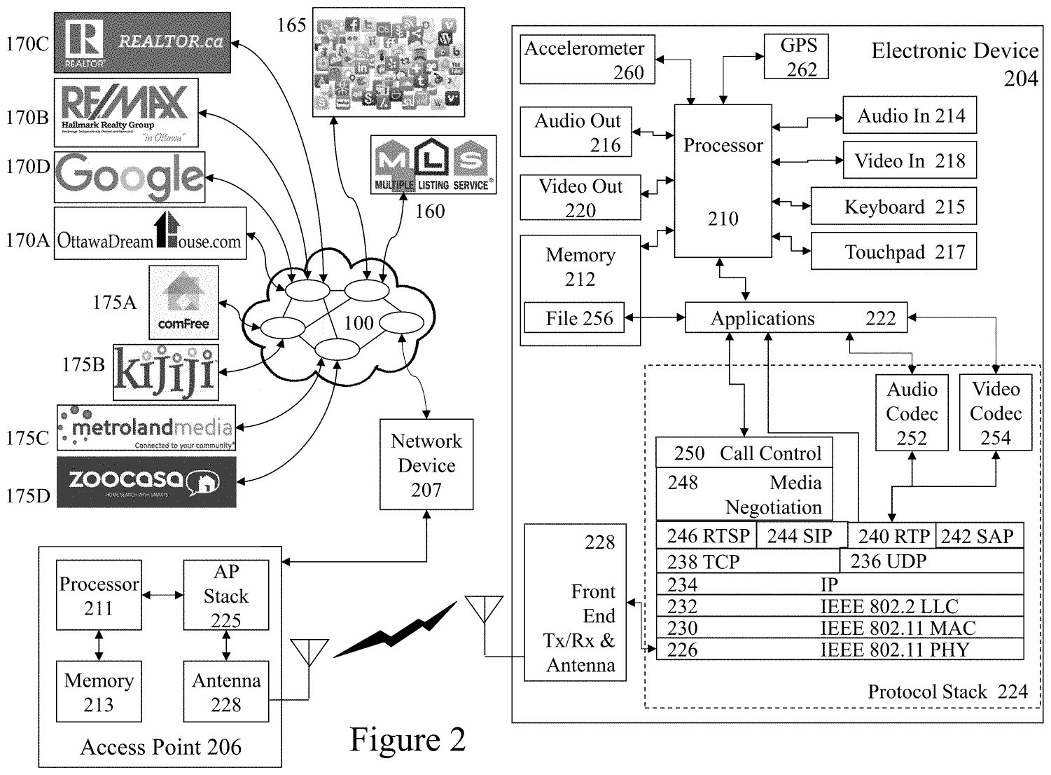

Now referring to FIG. 2 there is depicted an electronic device 204 and network access point 207 supporting ECS-EAAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network environment and therein Social Networks (SOCNETS) 165, first and second service provider networks 170A and 170B respectively, e.g. Asset Chaser™ and RE/MAX™, first and second service providers 170C and 170D respectively, e.g. Realtor™ and Google™, parts of the first and second service provider networks 170A and 170B respectively and first to fourth web networks 175A to 175D respectively, e.g. comFree™, Kijiji™, MetrolandMedia, and Zoocasa™ together with others, not shown for clarity.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, nonvolatile random-access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-0, DSL, Dial-Up, DOCSIS, Ethernet, G.hn, ISDN, MoCA, PON, and Power line communication (PLC).

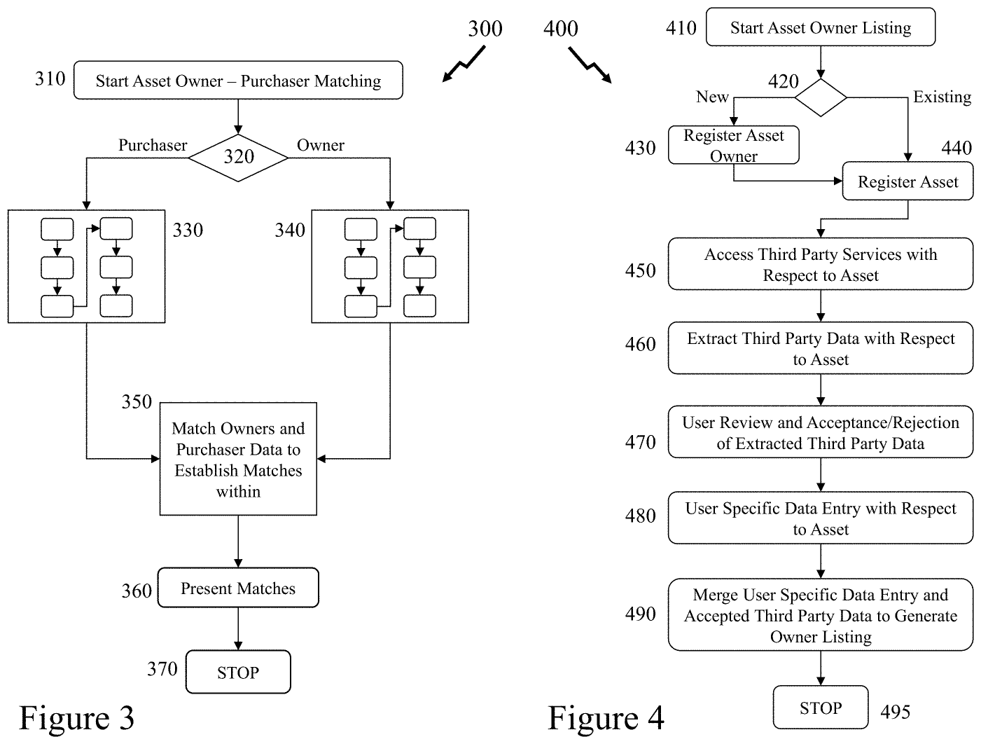

Referring to FIG. 3 there is depicted an exemplary process flow for matching asset owners to asset purchasers based upon information entered by both parties within an ECS-EAAP according to an embodiment of the invention. Accordingly, process 300 as depicted comprises the steps as follows:
Step 310 wherein the process starts;
Step 320 where based upon login credentials the process determines whether the user is an asset owner or a potential asset purchaser and proceed to either step 330 or step 340 accordingly;
Step 330 wherein the user is an asset purchaser and the process acquires information relating to the asset the asset purchaser is seeking to acquire before proceeding to step 350;
Step 340 wherein the user is an asset owner and the process acquires information relating to the asset the asset owner is seeking to or potentially seeking to dispose of or monetize before proceeding to step 350;
Step 350 wherein the asset owner data is matched to purchaser asset data or vice versa depending upon whether the user is an asset owner or potential asset purchaser;
Step 360 wherein the matches are presented to the user; and
Step 370 wherein the process stops.

Referring to FIG. 4 there is depicted an exemplary process flow for an asset owner to list an asset within an ECS-EAAP according to an embodiment of the invention. Accordingly, process 300 as depicted comprises the steps as follows:
Step 410 wherein the process starts;
Step 420 where the process determines whether the asset owner is registering for the first time or is an existing registrant to the ECS-EAAP, wherein it proceeds to step 430 or step 440 accordingly;
Step 430 wherein a new registrant enters their registration details before the process proceeds to step 440;
Step 440 wherein the asset owner registers the asset that they wish to list;
Step 450 wherein the ECS-EAAP accesses one or more third party services with respect to the asset in order to extract additional information relating to the asset;
Step 460 wherein the ECS-EAAP extracts data with respect to the asset from the one or more third party services;
Step 470 wherein the ECS-EAAP presents the extracted data to the asset owner for user review and their acceptance/rejection of the extracted third party data;
Step 480 wherein the asset owner provides details relating to the asset and their desired remuneration for disposing (selling, exchanging, etc.) of the asset (which can be monetary remuneration, exchange for another asset owned by the asset purchaser, etc.);
Step 490 wherein the ECS-EAAP merges the user specific data and the accepted third party data to generate a listing for the asset owner;
Step 495 wherein the process stops.

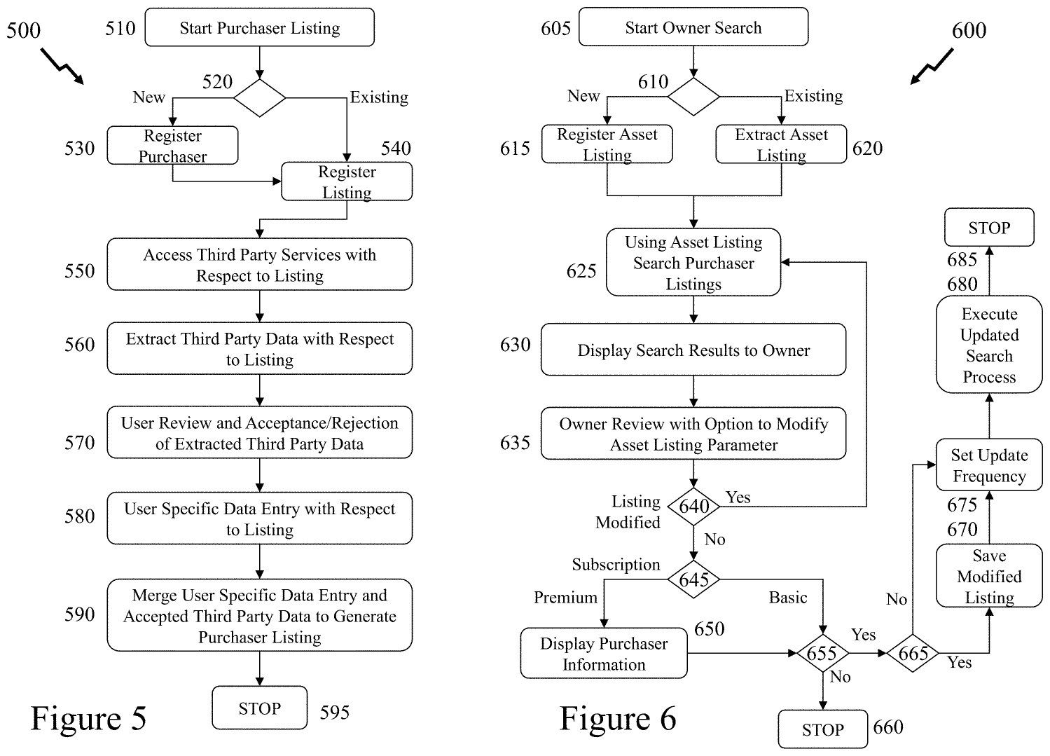

Referring to FIG. 5 there is depicted an exemplary process flow for a potential asset purchaser to list requirements for an asset they wish to acquire within an ECS-EAAP according to an embodiment of the invention. As depicted process 500 comprises the following steps:
Step 510 wherein the process starts;
Step 520 where the process determines whether the potential asset purchaser is registering for the first time or is an existing registrant to the ECS-EAAP, wherein it proceeds to step 430 or step 440 accordingly;
Step 530 wherein a new registrant enters their registration details before the process proceeds to step 440;
Step 540 wherein the potential asset purchaser registers the asset that they wish to acquire;
Step 550 wherein the ECS-EAAP accesses one or more third party services with respect to the asset in order to extract additional information relating to the asset;
Step 560 wherein the ECS-EAAP extracts data with respect to the asset from the one or more third party services;
Step 570 wherein the ECS-EAAP presents the extracted data to the potential asset purchaser for user review and their acceptance/rejection of the extracted third party data;
Step 580 wherein the potential asset purchaser provides details relating to the asset and their potential remuneration for acquiring the asset (which can be monetary remuneration, exchange for another asset owned by the potential asset purchaser, etc.);
Step 590 wherein the ECS-EAAP merges the user specific data and the accepted third party data to generate a listing for the potential asset purchaser;
Step 595 wherein the process stops.

Referring to FIG. 6 there is depicted an exemplary process flow for an asset owner to search for potential asset purchases with respect to an asset within an ECS-EAAP according to an embodiment of the invention. Accordingly, process 600 comprises the following steps:
Step 605 wherein the process starts;
Step 610 where the process determines whether the asset owner is registering a new asset for the first time or has an existing asset, wherein it proceeds to step 615 or step 620 accordingly;
Step 615 wherein the asset owner enters details of the new asset listing before the process proceeds to step 625;
Step 620 wherein the asset owner selects an existing asset they have previously registered and the ECS-EAAP extracts it before proceeding to step 625;
Step 625 wherein the ECS-EAAP uses the asset listing to search purchasing listings;
Step 630 wherein the ECS-EAAP displays the search results to the asset owner;
Step 635 wherein the asset owner reviews the displayed search results where the ECS-EAAP presents the asset owner with options for modifying the asset listing parameters;
Step 640 wherein the ECS-EAAP determines whether the asset owner has modified the asset listing wherein the process proceeds back to step 625 upon determining that the asset owner has modified the asset listing and to step 645 where no modification or further modification has been made;
Step 645 wherein the ECS-EAAP determines whether the asset owner has a basic subscription with the ECS-EAAP or has a premium subscription wherein the process proceeds to step 650 where the asset owner has a premium subscription or step 655 when they have a basic subscription;
Step 650 wherein the ECS-EAAP displays purchaser information relating to those purchasers with potential asset purchasing listing matching the asset owner's listing before proceeding to step 655;
Step 655 wherein the process receives the asset owner's input as to whether they wish to receive periodic updates on potential purchasers and proceeds to step 665 where the asset owner response is positive and step 660 where the asset owner response is negative;
Step 660 wherein the process stops;
Step 665 wherein the process determines whether the asset owner wishes to save the modified listing for subsequent updated search results or whether to use the asset listing as stored before progressing to steps 670 and 675 respectively;
Step 670 wherein the ECS-EAAP saves the modified listing for subsequent retrieval;
Step 675 wherein the ECS-EAAP receives the asset owner's indication of the frequency for the updates they wish to receive;
Step 680 wherein the ECS-EAAP establishes and executes an updated search process which provides updated search results to the asset owner and proceeds to step 685;
Step 685 wherein the process stops.

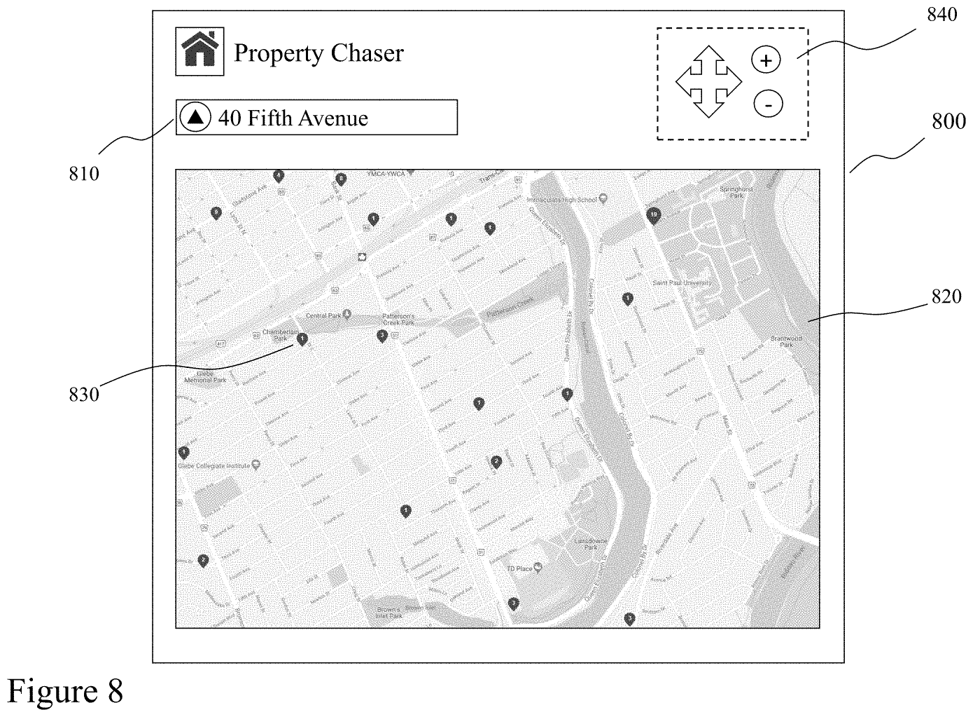

Accordingly, an ECS-EAAP according to various embodiments of the present invention provide a means by which asset owners can, anonymously to potential asset purchasers, reveal an asset that is potentially for disposal/exchange by the asset owner, with or without requiring that the asset owner establish a price, listing agreement, etc. with respect to the asset with as little or as much description of the asset as the asset owner wishes to provide. Similarly, potential asset purchasers can identify the types of asset(s) (or even specific asset(s)) that they would be interested in acquiring or purchasing, presenting their interest with as little or as much specificity as they wish, and at their option, with or without providing information about themselves, which may include for larger assets such as vehicles, properties, etc. details with respect to their financial ability to engage or complete the purchase to the extent they wish. As evident from FIGS. 8 to 11 as discussed below a variety of search tools may be used in establishing an asset within a listing by an asset owner or a listing by a potential asset purchaser which may include, but not be limited to, a location-based search using a third party search engine/mapping service; allowing a user to exploit a third party service providing acquired images of assets and/or acquired satellite imagery; etc. Where the asset of interest relates to a asset the third party service may allow a user to specify a geographic area of interest or to pinpoint a specific asset. Other suitable search based tool may be employed as known in the art including but not limited to textual queries.

Optionally, an ECS-EAAP according to various embodiments of the present invention may allow a potential asset purchaser to not only enter details relating to a potential asset but to also rank the order of importance of the features of the asset that they seek, such as by location, size, manufacturer, age, view, etc. Alternatively, an ECS-EAAP according to various embodiments of the present invention may establish an intention from a potential asset purchaser implicitly through tracking and analyzing the potential asset purchaser's search queries for an asset or assets or explicitly through parameters that potential asset purchasers specify. Within an ECS-EAAP according to various embodiments of the present invention a potential asset purchaser's intention refers to an interest in purchasing an asset. These intentions may be processed by an ECS-EAAP according to various embodiments of the present invention in order to form statistics. Accordingly, these statistics can be presented to asset owners allowing them to gauge demand for their asset using these intention statistics and decide whether to list their asset within an ECS-EAAP according to various embodiments of the present invention or to contact potential asset purchasers through various embodiments of the present invention to confirm a potential asset purchaser's interest and potentially proceed to a disposal of their asset to the potential asset purchaser.

Accordingly, by way of an example with respect to exemplary embodiments of the invention, the following discussion is made with respect to the asset being a asset. Accordingly, an asset owner enters their asset into an asset owner database, a discovery engine of an ECS-EAAP according to an embodiment of the invention matches asset features specified by the asset owner with desired features of potential asset purchasers. The asset owner may then be informed of how many ranked potential asset purchasers there are for whom there is a substantial match, within a matching limit or limits defined either by the ECS-EAAP by default or by the asset owner. In some ECS-EAAP embodiments of the invention these potential asset purchasers are presented as ranked potential asset purchasers, where the ranked potential asset purchasers may be a subset of the potential asset purchasers, where they may, for example, be ranked by their qualifications as entered by the potential asset purchasers. For example, these qualifications may vary according to the asset the asset owner lists and the “renumeration” the asset owner is seeking. For example, with a asset as the asset then these qualifications may include, but not be limited to, not having a asset to sell themselves (i.e. there is no chain on the potential asset purchaser side of the process), being qualified for a mortgage exceeding a predetermined percentage of the asset listing price as set by the asset owner, and potential to close the transaction within a time frame established by the asset owner.

Within an ECS-EAAP according to various embodiments of the present invention both the identity of the asset owner and the identities of those ranked potential asset purchasers may remain unknown to each other, there may follow a series of exchanges of further information, including the willingness of the ranked potential asset purchasers to enter a bid for the asset, the willingness to adjust conditions relating to the sale of the asset, etc. Within an ECS-EAAP according to various embodiments of the present invention the asset owner may be presented with different levels of information relating to the potential asset purchasers according to a subscription level of the asset owner with the ECS-EAAP.

Within an ECS-EAAP according to various embodiments of the present invention the asset owner may enter into an agreement (e.g., a commission agreement, or subscription agreement, etc.) with the potential asset purchaser directly or via a third party, e.g. another user, an entity, an enterprise, a service provider, third party service provider, etc., which operates an ECS-EAAP according to various embodiments of the present invention or is associated with an ECS-EAAP according to various embodiments of the present invention. Such a third party may facilitate aspects of a transaction between the asset owner and the potential asset purchaser. For example, where the asset is a asset then third party may be realtor, real estate broker, financial institution etc. Optionally, within other embodiments of the invention the third party may be a member of a service provider or third party service provider such that the asset owner and/or potential asset purchaser can establish that the third party is qualified to act within the transaction. For example, with a asset as the asset the third party may be required to a member of the Multiple Listing Service (MLS) which provides a suite of services to registered real estate brokers allowing them to establish and manage contractual offers of compensation (to other brokers), accumulate and disseminate information, establish appraisals, provide historical pricing information, etc. However, it would be evident that an ECS-EAAP according to various embodiments of the present invention may execute the entire process without accessing a third party.

An ECS-EAAP according to various embodiments of the present invention may allow an asset owner to gauge the demand for their asset, based on the number of potential asset purchasers who have expressed an interest in a asset with the asset features described by the asset owner and those desired features specified by potential asset purchasers. Accordingly, a potential asset purchaser may access the system, off-line or on-line through the Internet, etc. in order to specify the features for the asset they wish to acquire. This data being stored within a potential asset purchaser database wherein an asset owner can subsequently extract intentions from the potential asset purchasers using desired features that the asset owner establishes and the ECS-EAAP calculates intention statistics. For example, the asset owner may adjust the price they seek for the asset allowing them to dynamically gauge its impact upon the pool of potential asset purchasers allowing them to establish an asset valuation for subsequently contacting potential asset purchasers to seek an asset disposal or set an asset price within the database.

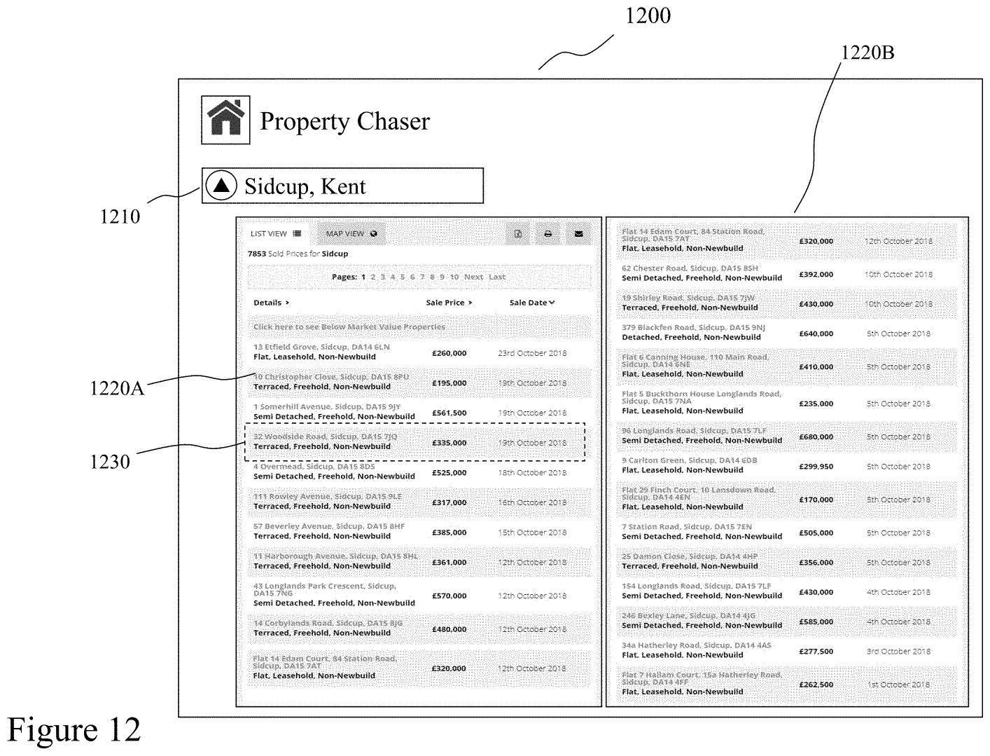

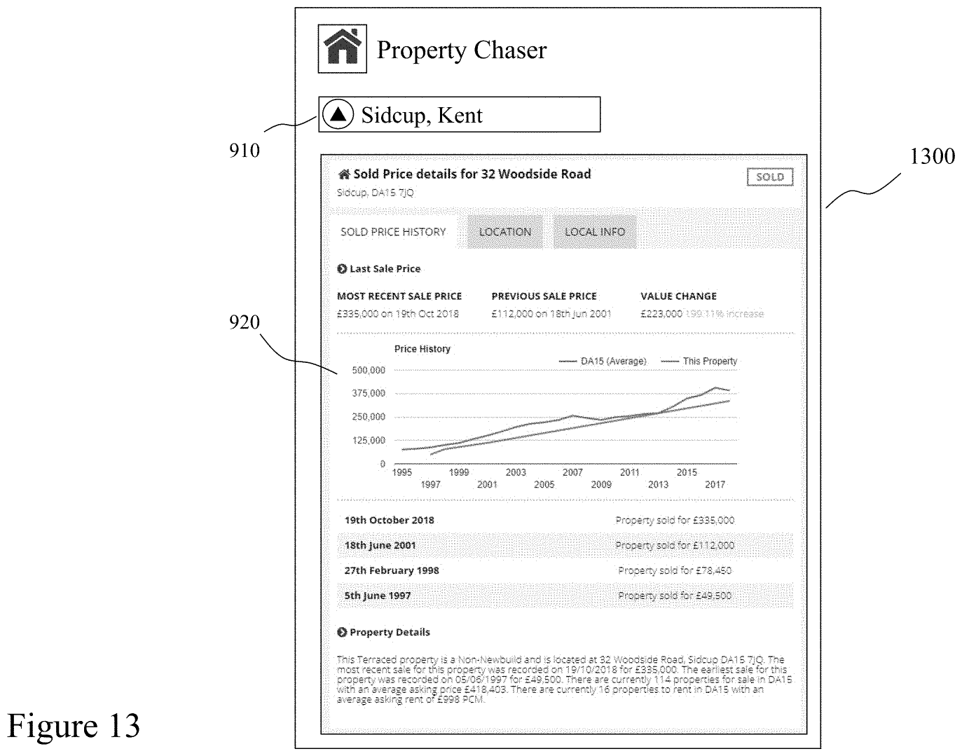

An ECS-EAAP according to various embodiments of the present invention may also allow an asset owner to establish a fair market value of their asset. Through the ECS-EAAP according to embodiments of the invention, the asset of the asset owner is compared with recent sales, pending sales, and/or current listings, with the assessed value of recent sales relative to the selling price (or asking price of current listings) and with other information gathered from relevant third party sources of information. For example, the asset owner, may, through various embodiments of the present invention, receive a report indicating that there are a number of potential asset purchasers for an asset that substantially shares the asset features specified by the asset owner in the system, of which a subset of the ranked potential asset purchasers have expressed a willingness to purchase the asset with substantially those specified features at a price in excess of a threshold. This threshold may be that set by the asset owner or it may be set in dependence upon the gathered third party information. For example, with respect to a property as the asset then such third party sources may be accessed by the asset owner (see for example FIGS. 12 and 13) allowing them to assess the information directly and make a decision or it may be processed automatically by the ECS-EAAP to present summary data to the asset owner. Accordingly, the third party sources may present historical information on transactions relating to the asset directly, where the asset is common (e.g. a specific vehicle model, a specific item of electronic equipment etc.) or relating to assets matching the listed asset within defined margins (e.g. same street, within predetermined radius of asset with same number of bedrooms, etc.).

An ECS-EAAP according to various embodiments of the present invention may guide the asset owner and/or potential asset purchaser through establishing a listing. This may be advantageous as the number of assets listed by potential asset purchasers having applicability to the unique matching of the asset's characteristics may generate too many results, requiring a time consuming and tedious task of sorting through the results or the laborious effort to rerun searches etc. an ECS-EAAP according to various embodiments of the present invention may potentially mitigate this by the asset owner and/or potential asset purchaser entering asset characteristics within a guided process tailored to the class of asset in question and establishing ranking of characteristics/features wherein the asset owner and/or potential asset purchaser can specify different weightings to different characteristics/features. For example, many features of an asset might be important to one potential asset purchaser but not another potential asset purchaser. Further, all potential asset purchasers are unlikely to have equal weight to specific features even if they are both deemed “priority features” of the asset. Accordingly, an ECS-EAAP according to various embodiments of the present invention can exploit these relative levels of importance in matching asset features, so that the search/match results are presented in a valuable manner. Examples of features themselves and which may have weightings associated within, considering the asset as a property, may include but not be limited to, location; number of bedrooms; number of baths; mountain view; city view; water view; lot size; fenced-in yard; attached garage; age; style; waterfront; cul-de-sac; fireplace; modern kitchen; home condition; media room; loft; townhouse; flat; proximity to a specific class of location or specific location; near a grocery store; near a hotel; amenities; high-rise; condominium; single family home; commercial class A building; transport options; etc.

An ECS-EAAP according to various embodiments of the present invention therefore would specific what they are interested in and then rank the importance of the attribute on a scale, such as from 0-10, for example, where something that is critical has a high score, something less critical a medium score, and something commonly referred to as a “bonus” or “nice to have” a low score, and some will have 0 so that they do not feature in ranking but are employed in matching searches. Accordingly, each asset listed by an asset owner can be scored against the features specified by the potential asset purchasers and the results are presented to the asset owner. For example, if there were 10 features identified by the potential asset purchaser and the combined score for all those attributes could be 100 (10 features at maximum scale of 10 each), then the asset owner may specify that they only wants to see listings where the aggregate score is at least 80, for example. This would allow the asset owner to gauge demand for their asset from those specifically seeking the features of the asset listed by the asset owner. Whilst, lowering the aggregate score may increase the number of potential asset purchasers “matching” it would be evident that many of these potential asset purchasers would have a low probability of acquiring the asset as other assets listed by other asset owners would have a higher matching score to their desired features.

An ECS-EAAP according to various embodiments of the present invention facilitates both an asset owner's on-line experience and a potential asset purchaser's on-line experience through presenting graphical user interfaces (GUIs) in respect to specifying the asset owner, the potential asset purchaser, the asset, and the potential asset purchaser's requirements. Such GUIs being displayed as the asset owner and/or potential asset purchaser accesses different features within an ECS-EAAP according to various embodiments of the present invention and accordingly the ECS-EAAP executes different processes such as those described and depicted in respect of FIGS. 3 to 6 and those below without reference to specific Figures.

For example, an ECS-EAAP according to various embodiments of the present invention may employ the following exemplary method for matching potential asset purchasers to asset owners. The exemplary method may comprise a subprocess for acquisition of information received from asset owners which is compiled into an asset owner database. In one embodiment, the asset owner may have been enticed to provide information to the asset owner database because of a notification received from one or more potential asset purchasers who are registered members of the ECS-EAAP. In another embodiment, the asset owner may enticed to register and provide information so as to receive a list of ranked potential asset purchasers without any notification.

The exemplary method may comprise a subprocess for acquisition of information received from potential asset purchasers which is compiled into a potential asset purchaser database. In one embodiment, the potential asset purchaser may have been enticed to provide information to the potential asset purchaser database because of a notification received from one or more asset owners who are registered members of the ECS-EAAP. In another embodiment, the potential asset purchaser may enticed to register and provide information so as to receive a list of ranked assets without any notification. Where one or more potential asset purchasers are contacted proactively the ECs-EAAP may exploit acquisition and analysis of social media content to identify potential asset purchasers based upon one or factors such as their purchasing history, new employment, getting married, having a child or children, etc.

The exemplary method may comprise a subprocess which relates to the execution of a matching algorithm to match potential asset purchasers and asset owners with respect to a specific asset, multiple assets, or a class of assets etc.

Accordingly, an exemplary subprocess for an asset owner may comprise the asset owner accessing a website related to the ECS-EAAP wherein the asset owner provides registration details such as their name, address, etc. together with details such as the asset that they wish to list. The ECS-EAAP then accesses one or more third party services to extract additional information. For example, where the asset is a property then the ECS-EAAP may contact, for example, a Multiple Listing Service, Land Registry, etc. in order to acquire additional information. Optionally, these third party services may be asset management services, manufacturers, mapping, etc. Accordingly, the ECS-EAAP extracts data from the third party services relating to the asset which are then presented to the asset owner for verification (e.g., the ECS-EAAP shows how many bedrooms, baths, asset size, and so on, and the asset owner is asked to verify the information). The ECS-EAAP may also identify using third party services additional information such as nearest schools, nearest hospital, local transport stops, etc. and their distance from the asset being listed. The asset owner may also be asked to provide additional information relating to the asset in an unstructured format, for example, or a structured format where the asset owner is presented with the acquired information together with fields relating to additional information that the ECS-EAAP seeks relating to the asset. For example, this may, for a property, relate to when was roof redone, furnace replaced, number of fireplaces, etc. Based upon the acquired information from the third party services and user entered information the ECS-EAAP then generates a listing for the asset.

Accordingly, an exemplary subprocess for a potential asset purchaser may comprise the potential asset purchaser accessing a website related to the ECS-EAAP wherein the potential asset purchaser provides registration details such as their name, address, etc. together with details such as the asset that they wish to seek. The ECS-EAAP then accesses one or more third party services to extract additional information relating to the asset the potential asset purchaser seeks. For example, the potential asset purchaser may be asked to specify, when considering a property, a postal code of a geographic area of interest, specify a geographic region through the potential asset purchaser defining a geofence, or select specific properties from a mapping service such as Google Street View or Google Earth etc. The potential asset purchaser may be asked to identify additional information such as preferred distance to nearest school(s), distance from the nearest hospital, distance from the local transport stops, etc. They also provide details such as how many bedrooms, size of lot, size of house, type of house, budgetary information etc. The asset owner may also be asked to provide this information relating to the asset in an unstructured format, for example, or a structured format where the potential asset purchaser is presented with any already acquired information together with fields relating to additional information that the ECS-EAAP seeks relating to the asset. For example, the property has a garage, has it been rewired, reroofed, local school ranking, estimated travel time to one or more destinations of the potential asset purchaser themselves or the potential asset purchaser's family, such as travel time to work, travel time to school, etc. Based upon the acquired information from the third party services and user entered information the ECS-EAAP then generates a listing for the potential asset purchaser relating to the asset they seek.

Accordingly, an exemplary subprocess for an asset owner may comprise the asset owner accessing a website related to the ECS-EAAP wherein the asset owner's information entered into the ECS-EAAP is matched with potential asset purchaser profile information from the potential asset purchaser database and/or the data is then used to derive a market analysis. With respect to a market analysis the ECS-EAAP compares the asset owner's asset to recent transactions from one or more third party services. Accordingly, the asset owner is presented with data including, but not limited to, an analysis of recently-sold properties matching theirs within a geographic area defined by the asset owner, properties that are currently on the market, and general sales trends.

Accordingly, an exemplary subprocess for an asset owner may comprise the asset owner accessing a website related to the ECS-EAAP wherein an asset owner is presented with a list of potential asset purchasers whose asset search features substantially match the features of the asset owner's asset. If the asset owner has subscribed to the ECS-EAAP at a level providing them with access to the potential asset purchasers' identities, then these are displayed to the user within a GUI.

Accordingly, an exemplary subprocess for an asset owner may comprise the asset owner accessing a website related to the ECS-EAAP after performing a search of potential asset purchasers may facilitate communications to those potential asset purchasers having asset profiles matching those of the asset the asset owner has listed. Where the user has subscribed to the ECS-EAAP at a level providing them with access to the potential asset purchasers' identities then the communications may be brokered through the ECS-EAAP using the asset owner and potential asset purchaser names etc. with or without providing the asset owner and/or potential asset purchaser with electronic addresses of the asset owner and potential asset purchaser. Alternatively, the ECS-EAAP may broker communications anonymously where the asset owner has subscribed to the ECS-EAAP at a level providing them with access to the potential asset purchasers' identities but wishes to remain anonymous or where the asset owner has not subscribed to the ECS-EAAP at a level providing them with access to the potential asset purchasers' identities.

Accordingly, an exemplary subprocess related to the ECS-EAAP may allow a potential asset purchaser to either affirm their continuing interest or withdraw from the process at any point during the information exchange process with the asset owner. In one embodiment, the ECS-EAAP does not broker communications but provides the asset owner with the necessary information to explicitly reaches out to a potential asset purchaser. All notifications may be transmitted by one or methods defined by the asset owner and/or potential asset purchaser when signing with the ECS-EAAP. Such notifications may include, short message service (SMS, commonly known as text), electronic mail, fax, or physical mail.

Accordingly, an exemplary subprocess the ECS-EAAP after may, until such time (if ever) as the asset owner elects to engage directly with the potential asset purchaser, serve as the electronic intermediary, acting as an exchange or clearinghouse for messages between potential asset purchasers and asset owners.

Accordingly, an exemplary subprocess of the ECS-EAAP may execute a matching algorithm that aligns potential asset purchasers and asset owners. For example, the ECS-EAAP may score the features of all listed asset owner assets and/or potential asset purchaser's sought after asset. This process may be defined by boundary conditions established by the potential asset purchaser. Subsequently, the ECS-EAAP gathers information pertaining to those assets whose scores substantially match the score of the asset of interest.

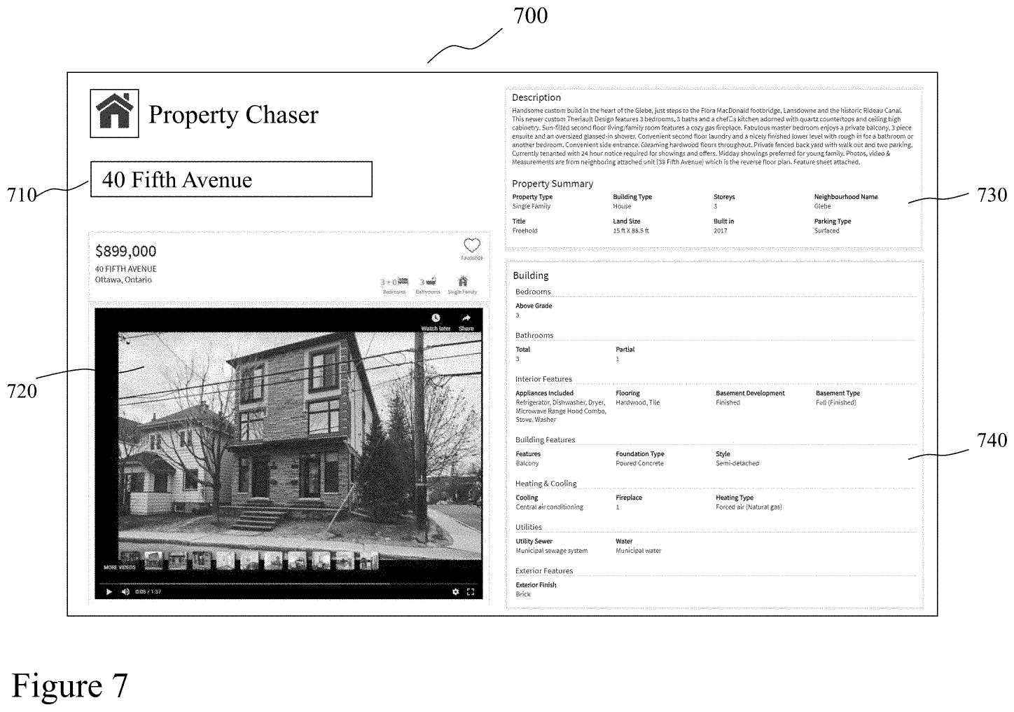

Referring to FIG. 7 there is depicted an exemplary webpage 700 of an asset posted by an asset owner as employed within embodiments of the invention. As depicted the webpage 700 comprises an Asset Identifier 710, an Image 720 of the asset, and asset description blocks 730 and 740. Optionally, Image 720 may be one of a plurality of images uploaded by the asset owner or acquired from a third party service. The data within asset description blocks 730 and 740 may be solely asset owner entered, solely acquired from third party services, or a combination of third party service information with asset owner entered data.

Referring to FIG. 8 there is depicted an exemplary webpage 800 of an asset owner GUI accessed by an asset owner within embodiments of the invention. The user as discussed above may be access information from one or more third party services with respect to an asset that they have posted. Within webpage 800 the ECS-EAAP has provided the user with a map based view of other properties within a region defined by the asset owner through the ECS-EAAP directly or through one or more third party services. As depicted the user has selected an asset they have listed in Listing Interface 810, in this instance “40 Fifth Avenue” wherein a Map 820 is presented of other properties within the region selected that match the asset to within a predetermined threshold. These being indicated by Pins 830 which include an indication of the number of assets they relate to. The asset owner can adjust the region depicted through the navigation interface 840 allowing them to move the region and/or adjust the zoom. Accordingly, the asset owner can view assets which have transferred ownership matching their asset within a predetermined region and over a predetermined time period. An optional timeframe of the information displayed may be presented to the user, not indicated in FIG. 8 for clarity, that allows the user to set the timeframe. This may be, for example, one week, one month, three months, six months, a year, two years etc.

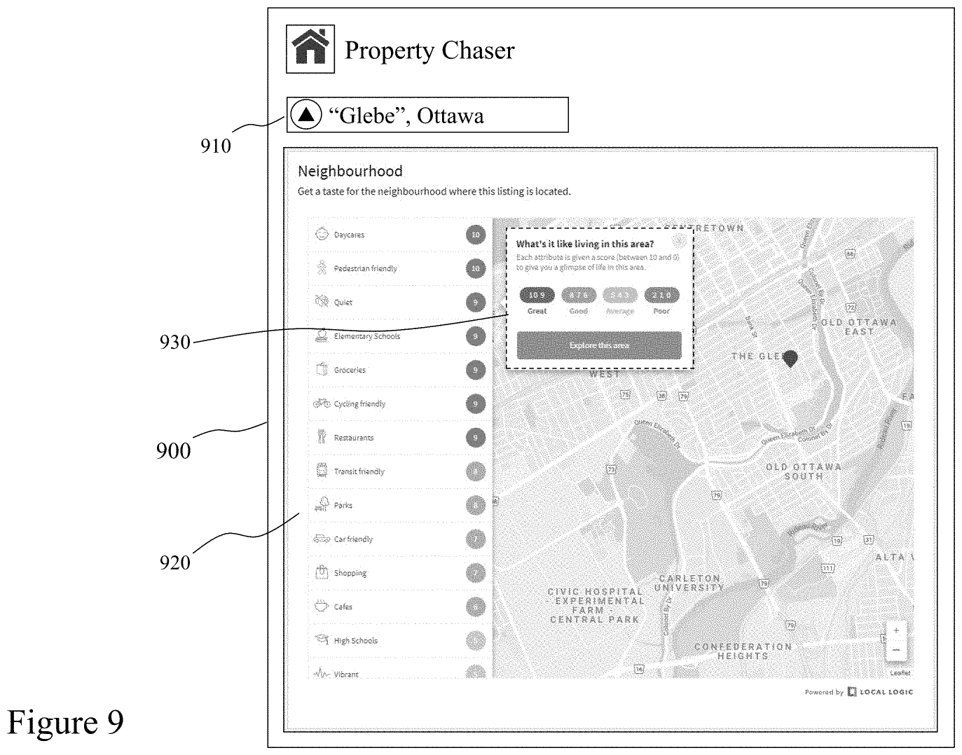

Referring to FIG. 9 there is depicted an exemplary webpage 900 of information relating to an asset class meeting specific search criteria entered by a potential asset purchaser as employed within embodiments of the invention. In this instance the potential asset purchaser has previously selected a predetermined geographical region with respect to their search for an asset. As depicted the user has established a filter in Filter 910 as “Glebe”, Ottawa. Accordingly, within the webpage 900 the user is then presented with Analysis 920. This presents data relating to the region of Ottawa, Ontario, Canada known as the “Glebe” indicating scores generated with respect to categories for the region such as Daycares, Pedestrian Friendly, Schools, Restaurants, etc. The Analysis 920 also indicates an overall Scoring 940 based upon the individuals contributing data to that summarized within the Analysis 920.

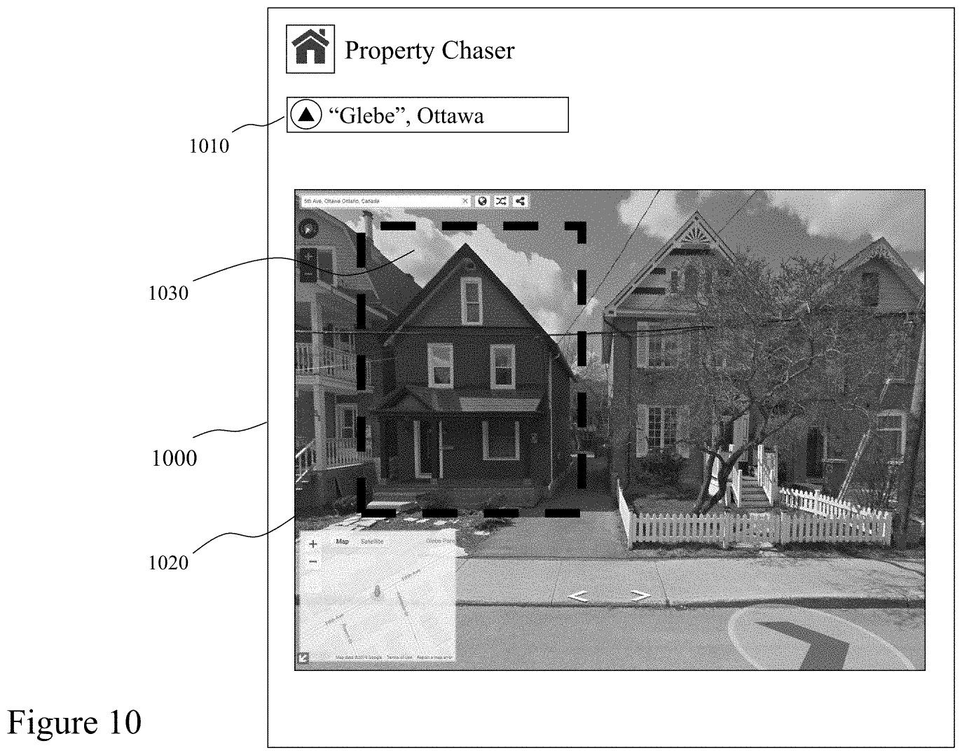

Referring to FIG. 10 there is depicted an exemplary webpage 1000 of an asset search performed by a potential asset purchaser as employed within embodiments of the invention. Accordingly, webpage 1000 comprises a Filter 1010 allowing the potential asset purchaser to establish a region wherein the interface 1020 is presented to the user which rather than a map based view is a street based view. Accordingly, the user can highlight a Region 1040 which the ECS-EAAP processes to establish one or more potential assets of interest. As depicted the user has identified a specific property, but it could be an apartment building, portion of a street, portion of a neighborhood etc.

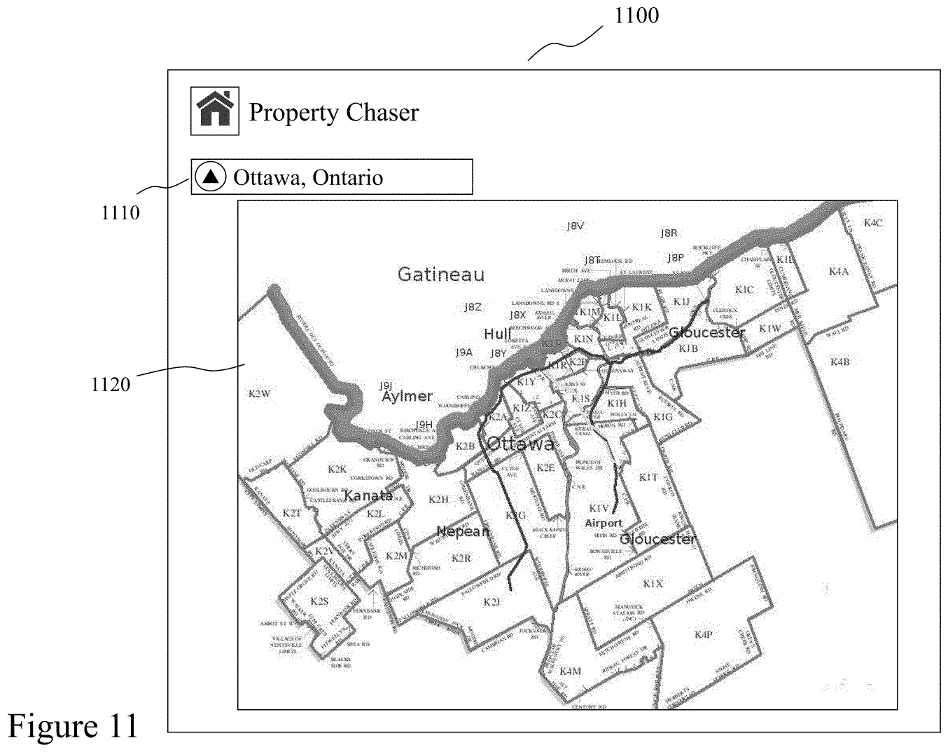

Referring to FIG. 11 there is depicted an exemplary webpage 1100 of an asset search performed by a potential asset purchaser as employed within embodiments of the invention wherein the user has selected within Filter 1110 a region, in this instance Ottawa, Ontario Canada, and accessed a third party service, in this instance a mail service, which presents a map 1120 identifying regions of Ottawa by their postal codes. Accordingly, the potential asset purchaser can establish a neighbourhood of interest through a recognized coding system such as postal codes, telephone area codes, etc.

Referring to FIG. 12 there is depicted an exemplary webpage 1200 of a historical asset realization search performed by an asset owner as employed within embodiments of the invention. In this instance, the asset owner has established a filter as “Sidcup, Kent” being a region in the United Kingdom and has accessed in first and second listings 1220A and 1220B respectively the recent sales records for house sales within that region. For example, identified listing 1230 represents “32 Woodside Road” representing a terraced freehold house which sold for £335,000 on 19 Oct. 2018. Alternatively, webpage 1200 may be depicted to a potential asset purchaser to aid their evaluation of a region.

Referring to FIG. 13 there is depicted an exemplary webpage 1300 of a historical asset realization resulting from a historical asset realization search performed by a user as employed within embodiments of the invention. Webpage 1300 representing an exemplary webpage presented to the asset owner upon their selection of an identified asset, such as identified listing 1230 in webpage 1200 in FIG. 12, wherein historical data relating to the asset, “32 Woodside Road” have been extracted from one or more third party services and are presented to the asset owner. Alternatively, webpage 1300 may be depicted to a potential asset purchaser to aid their evaluation of an asset or assets.

The inventor refers to a specific embodiment of the ECS-EAAP according to embodiments of the invention as applied to property as Property Chaser™. Accordingly, Property Chaser™ as an ECS-EAAP according to embodiments of the invention may provide features according to embodiments of the invention in conjunction with other features as known in the prior art. Accordingly, Property Chaser™ is an online ECS-EAAP service that allows users, referred to by the inventor as Property Chaser's to identify residential properties that they may wish to purchase if and when the identified property becomes available (for purchase). Users can specify a precise property address, street or geographical area. Users can also opt to use custom filters when searching by street or geographical location. Additionally, Property Chaser™ may be employed in assisting realtors to find prospective buyers in their area. With a membership to Property Chaser™ realtors and/or the property owners (asset owners) may have access to the properties that have been identified by the potential buyers. Property owners will have the opportunity to gain access to the system to view potential interests at the same level as, for example, a free user account.

Accordingly, property owners will be able to search for their own property to see if their property has been flagged as a property of interest by one or more property asset purchasers. With a membership at a certain level the property owners are able to send private messages to users who have identified interest in the property they own. At a higher membership level then the property owners may be able to establish an identity of the prospective asset purchasers. Optionally, within embodiments of the invention an ECS-EAAP such as Property Chaser™ allows users to be notified by the system when their identified property has been placed onto a real estate market, such as the Multiple Listing Service in North America, if they have not been previously contacted by the asset owner through the ECS-EAAP (Property Chaser™). Realtors, through their memberships, may have access to users who have identified an interest in purchasing a specific property, a property on a desired street or their preferred geographical location. Accordingly, realtors may be able to send messages through the system offering to provide realtor services to. The users can then choose to communicate with the realtor or decline any further interactions. Embodiments of the invention would maintain user information as confidential and such data may be internally controlled by the ECS-EAAP and not to a realtor or other third party whereby the ECS-EAAP routes all communication through itself.

Within embodiments of the invention users may be able to create a free account to access the system. Users will with free accounts may not be required to provide detailed personal information but may also be blocked from accessing certain features such as communications with property asset purchasers. With a paid subscription account, the user may be able to unlock these features although to enable these features personal details such as full name, electronic address etc. Users may also be asked their preferred method of communication to receive possible notifications in regard to a property they have identified as a potential purchase or have listed in order to be notified when a potential asset purchaser has added an asset requirement that matches the user's listed asset. Users will be able to identify multiple properties by using a specific search or a combination of the available searching methods.

Within embodiments of the invention users will be able to see which properties have already been identified as a property of interest by other users, either asset owners or potential asset purchasers. Within some embodiments of the invention potential asset purchasers may be restricted from being able to send private messages through the system whilst asset owners may be able to send private messages. However, users would be able to respond to private messages even if they are unable to initiate communications with asset owners etc. through their membership.

Within embodiments of the invention a realtor who would like access to the system to view prospective buyers in specific areas may have to create a realtor agent account and pay a subscription fee. Realtors may have full access to potential asset purchasers who have specified interest in a precise property address, street or geographical area. Using the information provided by the potential asset purchasers, the realtor may be able to send a private message through the system to the users who have identified interest in a property for sale.

Within embodiments of the invention asset owners (property owners) will have the opportunity to gain access to the system to view potential interests at the same level as a free user account. As such asset owners may be able to search their own property to see if their property has been flagged as a property of interest. Upon registering with the ECS-EAAP the asset owner is then able to send private messages. Asset may be able to purchase a membership for a predetermined period of time or a predetermined number of messages etc. For example, time based memberships may be 3 month, 6 month, 9 month, 12 month etc. as either one-off payments or automatically renewing subscriptions until cancelled. A membership account for asset owners will, in some embodiments of the invention, proof of the asset owners ownership. This may be through uploading a receipt for the purchase of the asset or verification through a third party service such as city tax records, driving license authority, etc. The asset owner will only be able to send a private message through the system to the users who have established an interest in a property having a match exceeding a predetermined threshold.

The system allows users, either asset owners or potential asset purchasers to identify a precise property address by entering it in to the system using the property's physical address; street number, street, province and postal code. Users will also be able to identify a specific street within a city or town by entering the street name and city or town and province (or state etc.). Alternatively, users can set a geographical area, geofence, defined radius around a specified point, as in a neighbourhood or city. Other than the precise property address option, users will have access to custom filters which will eliminate identifying all properties within a specific street or geographical area. The filters will have price option, such as a minimum and maximum amount, whilst other filter options may depend on the availability of information through a third party system or systems. Optionally, a filter for the maximum and minimum price, may be pulled from a third party service, for example within the province of Ontario, Canada this may be the Municipal Property Assessment Corporation (MPAC) using their Municipal Connect database. Third parties such as MPAC assess and classifies all properties in Ontario in compliance with regulations set by the Government of Ontario. Accordingly, Property Chaser™ may exploit these third party services including realtors etc. in order to establish an evaluated market value amount for residential properties. Using the MPAC database, the system will be able to provide a more accurate evaluation of how much each property is worth although it would be evident that the actual market price for a property may exceed the value set by such a third party as MPAC.

Within embodiments of the invention an asset owner or potential asset purchaser may be able to see that another user has identified an asset of potential interest. The asset owner or potential asset purchaser can then create a paid membership for a predetermined period of time and send a private message through the system to the users who have identified interest in their asset. Potential asset purchasers and asset owners may not be able to send private messages to each other without having listed an asset or a potential interest in an asset.

Within embodiments of the invention a third party service may comprise a realtor system such as that from the Canadian Real Estate Association (CREA) through their Data Distribution Facility (DDF). Whilst information gathered from the DDF consists of only its current available listings for properties this may aid an asset owner or potential asset purchaser in establishing a market value for an asset. More specifically, when a new property is added to the CREA website or an affiliate site the links between the ECS-EAAP and the DDF may be exploited to automatically add these new properties to the ECS-EAAP database. Accordingly, users are then notified by the ECS-EAAP by private message or electronic mail etc. that a new match has been flagged. Many realtors have access to upcoming properties prior to them hitting the market and accordingly, a realtor who has created and paid an annual fee will be able to see if there has already has been interest in the property they are about to list and accordingly the realtor is able to send a private message to all users who have listed the specific property, street or geographical area as a property of interest. Continued communication and the potential viewing or sale may be dealt solely by the ECS-EAAP, solely outside the ECS-EAAP, or a combination thereof.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
establishing a plurality of sets of first data upon a server established by a plurality of potential asset purchasers, each set of first data relating to characteristics of a first asset established by a potential asset purchaser of the plurality of potential asset purchasers which they seek to acquire;
establishing second data upon a server established by an asset owner, the second data relating to a second asset owned by the asset owner;
performing a matching process of the second data with the plurality of sets of first data;
providing to the asset owner a set of results of the matching process, the set of results comprising at least a number of the potential asset purchasers within the plurality of potential asset purchasers whose first data matches the second data; wherein
the asset owner has no association with the plurality of potential asset purchasers other than that they are both registered with a software application in execution upon the server.

2. The method according to claim 1, further comprising
enabling the asset owner to communicate with one or more of the potential asset purchasers within the set of results.

3. The method according to claim 1, further comprising
notifying each potential asset purchaser within the plurality of potential asset purchasers that an asset matching their set of first data exists.

4. A method comprising:
providing an electronic communication from a server notifying an asset owner that a potential asset purchasers exist for an asset registered by the asset owner with at least one of a software application in execution upon the server and a software service hosted by the server; wherein
the electronic communication is triggered upon determining a match between a plurality of sets of first data established by a plurality of potential asset purchasers and second data established by the asset owner;
each set of first data relating to characteristics of a first asset established by a predetermined potential asset purchaser of the plurality of potential asset purchasers which they seek to acquire;
the second data upon a server was established by the asset owner relating to a second asset owned by the asset owner; wherein
the identity of the potential asset purchaser of the plurality of potential asset purchasers is hidden from the asset owner during subsequent electronic communications when the asset owner has a first subscription level with the at least one of the software application in execution upon the server and the software service hosted by the server; and
the identity of the potential asset purchaser of the plurality of potential asset purchasers is revealed to the asset owner during subsequent electronic communications when the asset owner has a second subscription level with the at least one of the software application in execution upon the server and the software service hosted by the server.

5. A device comprising:
a server coupled to a communications network comprising a microprocessor, a database, and a network interface; wherein
the server is configured to send an electronic communication to an asset owner notifying the asset owner that a potential asset purchaser exist for an asset registered by the asset owner with at least one of a software application in execution upon the server and a software service hosted by the server;
the electronic communication is triggered upon determining a match between a plurality of sets of first data established by a plurality of potential asset purchasers and second data established by the asset owner;
each set of first data is stored within the database and relates to characteristics of a first asset established by a predetermined potential asset purchaser of the plurality of potential asset purchasers which they seek to acquire;
the second data is stored within the database and relates to characteristics established by the asset owner relating to a second asset owned by the asset owner; wherein
the server is configured to hide the identity of the potential asset purchaser of the plurality of potential asset purchasers from the asset owner during subsequent electronic communications when the asset owner has a first subscription level with the at least one of the software application in execution upon the server and the software service hosted by the server; and
the server is configured to reveal the identity of the potential asset purchaser of the plurality of potential asset purchasers to the asset owner during subsequent electronic communications when the asset owner has a second subscription level with the at least one of the software application in execution upon the server and the software service hosted by the server.

6. A server comprising:
a microprocessor;
a network interface coupled to a communications network;
a memory; wherein
the server is configured to:
store a plurality of sets of first data within the memory established by a plurality of potential asset purchasers, each set of first data received from a first electronic device associated with the potential asset purchaser of the plurality of potential asset purchasers connected to the communications network relating to characteristics of a first asset established by a potential asset purchaser of the plurality of potential asset purchasers which they seek to acquire;
store second data within the memory established by an asset owner, the second data relating to a second asset owned by the asset owner and received from a second electronic device associated with the asset owner connected to the communications network;
perform a matching process of the second data with the plurality of sets of first data;
provide to the asset owner electronic data relating to a set of results of the matching process, the set of results comprising at least a number of the potential asset purchasers within the plurality of potential asset purchasers whose first data matches the second data; wherein
the asset owner has no association with the plurality of potential asset purchasers other than that they are both registered with a software application in execution upon the server.

7. The server according to claim 6, wherein
the server is further configured to enable the asset owner to communicate with one or more of the potential asset purchasers within the set of results.

8. The server according to claim 6, wherein
the server is further configured to notify each potential asset purchaser within the plurality of potential asset purchasers that an asset matching their set of first data exists.
